(19) United States
(12) Patent Application Publication
(10) Pub. No.: US 2013/0036060 A1
(43) Pub. Date: Feb. 7, 2013

(54) FRAMEWORK FOR MANAGING PROJECTS IN AN ORGANIZATION

(71) Applicants: Satyendra Kumar, Bangalore (IN); Aman Kumar Singhal, Bangalore (IN); Sarita Bhandari, Mumbai (IN)

(72) Inventors: Satyendra Kumar, Bangalore (IN); Aman Kumar Singhal, Bangalore (IN); Sarita Bhandari, Mumbai (IN)

(73) Assignee: Infosys Limited, Bangalore (IN)

(21) Appl. No.: 13/327,578

(22) Filed: Dec. 15, 2011

(30) Foreign Application Priority Data
Aug. 1, 2011 (IN) 2630/CHE/2011

(51) Int. Cl. G06Q 10/06

(52) U.S. Cl. 705/301

(57) ABSTRACT

The embodiments of the present disclosure provide a framework for managing lifecycle of a project in an organization. The framework comprises a project management module configured to provide plurality of guidelines to execute a project in a global context, a behavior module configured to provide a plurality of skill sets required for the effective execution of the project, a focus module configured to generate efficient outcomes in the project performance and a support module configured to provide integrated project management. The framework provides multiple levels of project management certifications to address the competency needs as per various roles requirement in an organization. The disclosure also provides a method of implementing project management certifications which are mapped as per various roles requirements in an organization.

### TECHNICAL FIELD

The present disclosure relates to the field of project management. More particularly the embodiments of the disclosure relate to a framework for managing life cycle of a project in an organization.

### BACKGROUND OF THE DISCLOSURE

In the current business environment, effective project management is a key factor in the success of many enterprises. Therefore, today's Information Technology (IT) organizations have become increasingly concerned about effective project management. Accordingly, IT organizations typically strive to achieve effective project management by implementing a full life cycle project management solution, wherein each project in an IT organization's portfolio is created and developed according to a comprehensive lifecycle process.

In general, a comprehensive project life cycle management framework must enable the IT organizations to perform executive monitoring and control of its projects, to utilize current industry knowledge and best-practices in managing the project, to have a more detailed view in identifying problems as early as feasible in project's lifecycle, to effectively balance the lifecycle process and to continually strive to reduce overall time to progress through the project lifecycle process. Also, the framework must show improvements in project operational parameters like margins, on time delivery, quality and productivity.

In a conventional system, a generic project management frameworks exist covering competencies like scope management, time management, cost management, quality management, communication management, risk management, human resource and procurement. Interpretation of generic project management competencies to IT projects does not lead to effective implementation of these concepts. Also, they do not provide unique competencies which are essential to deliver IT projects successfully. Generic project management framework does not provide competency development for all roles in project management streams. Also role based certifications to address the competency needs as per various roles requirement in an organization do not exist.

The present disclosure focuses on IT-specific challenges and experiential learning through case studies and exercises makes this offering unique, robust and relevant to the industry. It provides a comprehensive framework with a set of competencies, methodologies, processes, tools and techniques specific to the IT industry by providing business model and work ethics, global delivery model, role based project management competency, behavior skills required for project management, competencies, frameworks, skill sets, processes, tools and techniques focusing on continuous improvements across project management lifecycle.

### SUMMARY

This section provides a general summary of the disclosure, and is not a comprehensive disclosure of its full scope or all of its features.

Additional features and advantages are realized through the techniques of the present disclosure. Other embodiments and aspects of the disclosure are described in detail herein and are considered a part of the claimed disclosure.

An exemplary embodiment of the present disclosure provides a framework for managing lifecycle of a project in an organization which comprises a project management module to provide plurality of guidelines to execute a project in a global context. Further, the framework comprises a behavior module to provide a plurality of skill sets required for the effective execution of the project. Finally, the framework is configured with a focus module to generate efficient outcomes in the project performance and a support module to provide integrated project management.

An embodiment of the present disclosure provides a method of implementing project management certifications. Firstly, the competencies and issues involved in one or more stages in a life cycle of a project are identified. Then the project management certifications are configured based on the competencies and the issues. Further the project management certifications are mapped to various roles requirement in an organization. The effectiveness of the project management certification is measured, based on the outcome of the measurement they are refined to meet changes in the competencies and the issues in one or more stages in the life cycle of the project. Finally, the project management certifications are finalized.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristics of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 is an exemplary block diagram illustrating a framework for managing life cycle of a project in an organization.

FIG. 2 diagrammatically illustrates a method of implementing project management framework certification.

FIG. 3 illustrates an example process of mapping project management certifications and various roles required for project management in an organization.

FIGS. 4-5 shows modules present in the project management certifications.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

An embodiment of the present disclosure provides a framework for managing lifecycle of a project in an organization. One or more stages in the lifecycle of the project comprises a pre-initiation stage, initiation stage, planning stage, execution and control stage and closure stage.

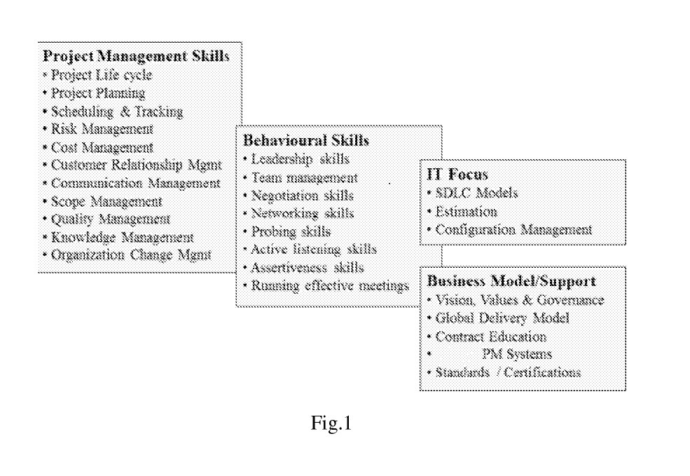

FIG. 1 diagrammatically illustrates the project management framework. The project management framework comprises a project management module configured to provide plurality of guidelines to execute a project, a behavior module configured to provide a plurality of skill sets required for the effective execution of the project, a focus module configured to generate efficient outcomes in the project performance, and a support module configured to provide integrated project management.

In an embodiment, the project management framework receives inputs from quality models, various other frameworks and general management concepts. The framework make use of various modules configured in the framework to provide multiple levels of project management certifications to address the competency needs as per various roles requirement in an organization.

The project management module comprises a project life cycle module configured to provide an organizing structure to align project objectives with appropriate technologies and resources, a scope management module configured to define scope of the project and to manage scope changes in the one or more stages of the lifecycle of the project. It also comprises a project planning module to generate a strategy plan for achieving a plurality of strategic objectives associated with the project. The processes involved under planning are identifying specific work to be performed and the goals that define the project, providing documented estimates regarding schedule, resources and cost for planning, tracking, and controlling the project, obtaining organizational commitments that are planned, documented, and agreed upon, and establishing a baseline of the plan from which the project will be managed. It further comprises a scheduling and tracking module configured to schedule a workflow to the project wherein the workflow comprises steps of deciding initial estimate of the project duration, identifying and sequencing the activities in the project, creating and optimizing the resources, optimizing the duration and tracking the project schedule effectively

The project management module further comprises a risk management module configured to analyze risks associated with the project, a cost management module configured to analyze the project budget considering various sources of expenses, a customer relationship module configured to analyze complaints, feedback, and appreciation of the project from a customer, a communication management module configured to provide communication mode for different stakeholders to discuss the project status effectively, a knowledge management module configured to define procedures for managing knowledge obtained during the one or more stages of the lifecycle of the project, a quality management module configured to generate verification and validation techniques to assure the quality of the project, an organization change management module configured to create a mechanism for managing change in the structure of the organization in accordance with the plurality of strategic objectives, and a performance management module configured to ensure that the goals of the project are consistently being met in an effective and efficient manner.

The behavior module comprises one or more skill sets including but not limiting to leadership skills, team management skills, negotiation skills, networking skills, probing skills, active listening skills, assertiveness skills and running effective meeting skills.

The focus module comprises a configuration management module configured to focus on establishing and maintaining consistency of the projects performance and its functional and physical attributes with its requirements, design, and operational information in the one or more stages of the lifecycle of the project, and an estimation module configured to estimate in-source and outsourced projects, based on size of the project and productivity, effort, and schedule involved in the lifecycle of the project.

The support module provides integrated project management whose purpose is to establish and manage the project and the involvement of relevant stakeholders according to an integrated and defined process that is tailored from the organization's set of standard processes. It comprises a vision module configured to provide and integrate organization vision in to the one or more stages in the lifecycle of the project, a knowledge management module configured to define procedures for managing knowledge obtained during the one or more stages in the lifecycle of the project, a resource management module configured to select optimal resources required for the execution of the project and also to track the resource usage in one or more stages in the life cycle of the project, a global delivery model to ensure the distribution of application and project lifecycle activities and resources, while ensuring their integration, a stake holder management module configured to identify and manage interests of one or more stake holders in the organization, and a vendor management module configured to manage vendor engagements.

During pre-initiation stage, a background study related to the project is performed. The background study includes understanding a strategy plan identified by a customer and identifying the vision of the customer that is to be achieved. It also includes collecting data related to the technology and market trends, IT strategy of the customer, and the budget.

During initiation stage, the strategic goals, objectives and scope of the project are defined. This includes analyzing the strategic plan and identifying the business processes impacted by the strategic plan. A problem statement is defined based on the analysis of strategic plan, business impacts and the data collected in the pre-initiation stage. Further, the business processes related to the problem in the problem statement is assessed. Based on the above analysis, one or more goals and objectives of the program are established. The one or more strategic goals and objectives may also be validated from the customer.

After establishing the strategic goals and objectives, project estimation is performed wherein the project is estimated based on its size, and productivity, effort, and schedule involved in the lifecycle of the project. A quality plan is defined for the project to generate verification and validation techniques to assure the quality of the project. The strategy to attain the quality is identified to improve the goals set for the project.

Further, the project organization is defined wherein the human resources with the required skill sets and competencies required for the project is identified and a training plan is defined to provide domain competence and non-functional aspects like performance, scalability to the human resources. A knowledge management infrastructure is built to define procedures for managing knowledge obtained during the one or more stages of the lifecycle of the project. The configuration management is set up to focus on establishing and maintaining consistency of the projects performance and its functional and physical attributes with its requirements, design, and operational information in the one or more stages in the lifecycle of the project. A governance mechanism is set up to define internal and external reporting structure wherein internal is the reporting team and external involves sponsor, client contact etc., and communication plan which includes meeting, reporting, mail, telecom, and issue escalation policy. The risks associated with the projects are identified and analyzed and the project is scheduled with resources and timelines. A project plan is created to perform group reviews and the project objectives are communicated to the team members to start off with the project.

During execution stage, the process involves taking the actions necessary to ensure that the work described in the planning activities will be completed. The main outcome of which is the delivery of the actual work of the project processes involved. Control stage is the process of measuring progress towards the project objectives, monitoring deviation from the plan, and taking corrective action to match progress with the plan. The ideal outcome of which is to successfully complete a project by delivering the agreed upon project scope within time, cost, and quality constraints. If changes to project objectives or plans are required, controlling processes ensure that they are made in an efficient and effective manner to meet stakeholder needs and expectations. During the closing processes, the project team works to gain acceptance of the end product and bring the phase or project to an orderly end, the key outcomes of which are formal acceptance of the work and creation of closing documents such as a project audit and lessons learnt report.

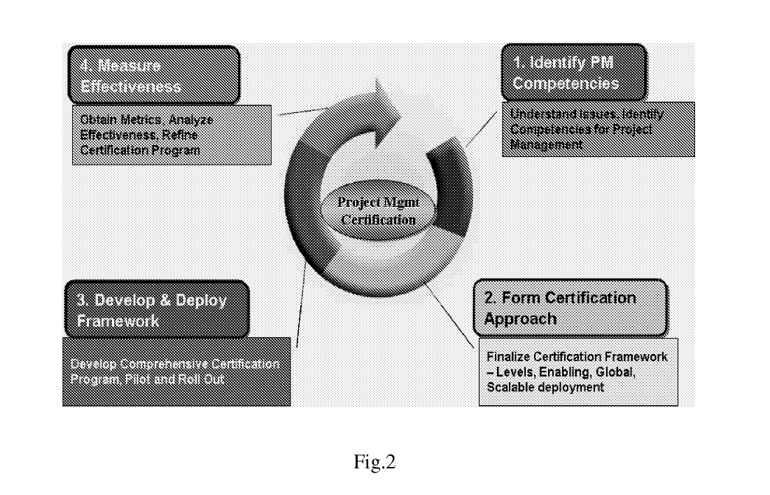

FIG. 2 illustrates a method of implementing a project management certification which is required to manage the life cycle of the project at various stages. In an embodiment, competencies and issues involved in one or more stages in a life cycle of a project is identified. The project management certifications are configured based on the competencies and the issues. The project management certifications are mapped to the various roles required in an organization for managing the projects. The effectiveness of the project management certifications is measured which is then refined to meet changes in the competencies and the issues in one or more stages in the life cycle of the project and finally the project management certifications are finalized.

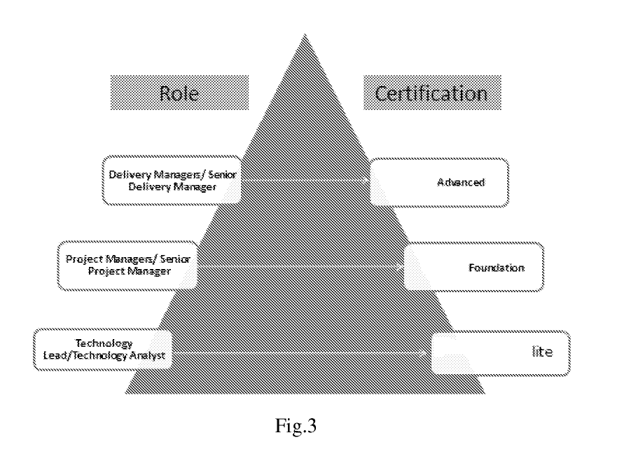

FIG. 3 illustrates an example process of mapping project management certifications and various roles for managing project in an organization. The project managing certifications are classified into different levels based on the role requirement in an organization for managing the projects. For example, the certifications are classified into lite, foundation and advanced levels. As an example, the lite certification is mapped for technology analyst, the foundation certification is mapped for senior manager and the advanced certification is mapped for delivery manager.

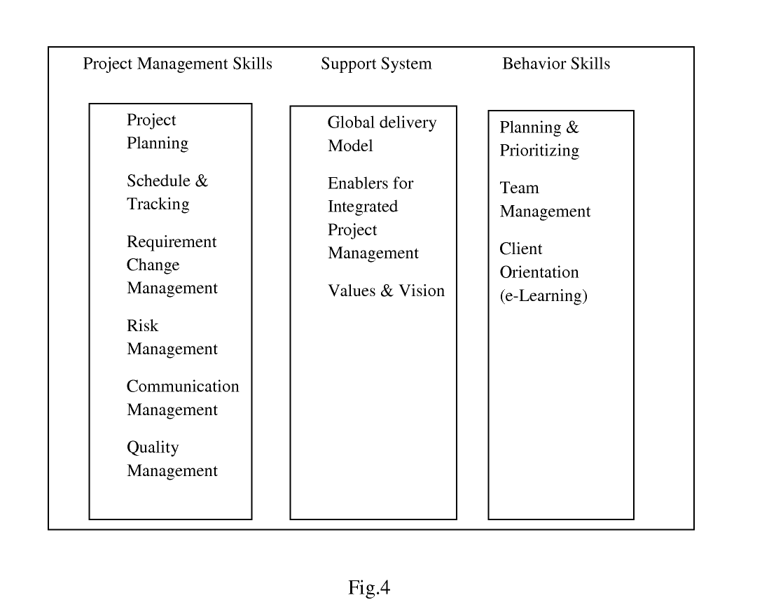

The lite certification comprises one or more modules selected from a group comprising project planning module, scheduling and tracking module, change management module, risk management module, communication management module, quality management module, team management module, global delivery model, enablers for integrated project management and vision module as shown in the FIG. 4

The foundation certification comprises all the modules in the project management framework as shown in the FIG. 1.

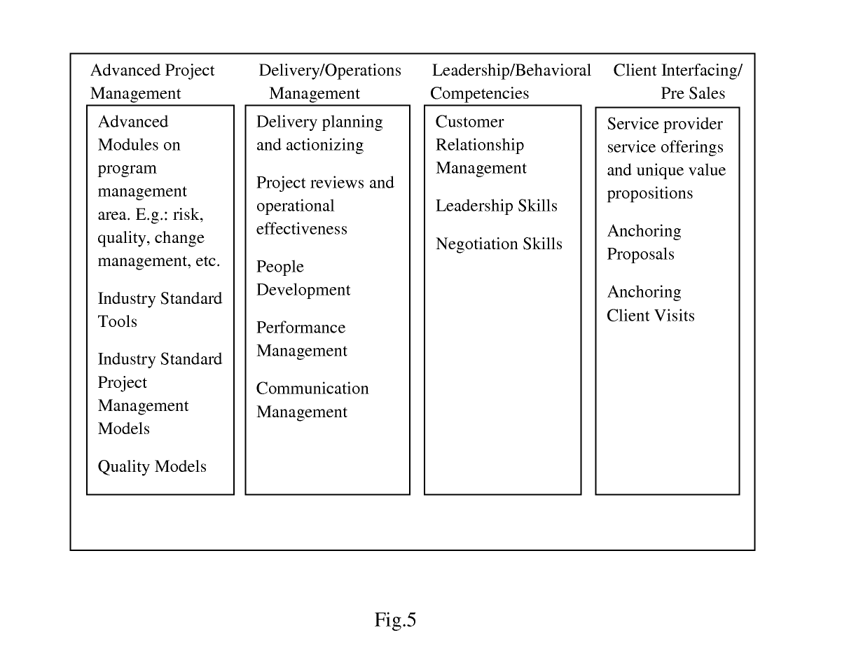

The advanced certification comprises one or more modules selected from a group comprising risk management module, quality management module, change management module, customer relationship management module, communication management, performance management module, leadership skills, negotiating skills, delivery planning skills, project reviewing skills, anchoring and proposing skills as shown in the FIG. 5

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A framework for managing lifecycle of a project in an organization comprising:
a project management module configured to provide plurality of guidelines to execute a project;
a behavior module configured to provide a plurality of skill sets required for the effective execution of the project;
a focus module configured to generate efficient outcomes in the project performance; and
a support module configured to provide integrated project management;

2. The framework as claimed in claim 1, wherein the project management module comprises:
a project life cycle module configured to provide an organizing structure to align project objectives with appropriate technologies and resources;
a scope management module configured to define scope of the project and to manage scope changes in the one or more stages in the lifecycle of the project;
a project planning module configured to generate a strategy plan for achieving a plurality of strategic objectives associated with the project;
a scheduling and tracking module configured to schedule a workflow to the project wherein the workflow comprises steps of deciding initial estimate of the project duration, identifying and sequencing the activities in the project, creating and optimizing the resources, optimizing the duration and tracking the project schedule effectively;
a risk management module configured to analyze risks associated with the project;
a cost management module configured to analyze the project budget considering various sources of expenses;
a customer relationship module configured to analyze complaints, feedback, and appreciation of the project from a customer;
a communication management module configured to provide communication mode for different stakeholders to discuss the project status effectively;
a knowledge management module configured to define procedures for managing knowledge obtained during the one or more stages in the lifecycle of the project; a quality management module configured to generate verification and validation techniques to assure the quality of the project;
an organization change management module configured to create a mechanism for managing change in the structure of the organization in accordance with the plurality of strategic objectives; and
a performance management module configured to ensure that the goals of the project are consistently being met in an effective and efficient manner;

3. The framework as claimed in claim 1, wherein the behavior module comprises one or more skill sets selected from the group consisting of:
leadership skills, team management skills, negotiation skills, networking skills, probing skills, active listening skills, assertiveness skills and running effective meeting skills.

4. The framework as claimed in claim 1, wherein the focus module comprises:
a configuration management module configured to focus on establishing and maintaining consistency of the projects performance and its functional and physical attributes with its requirements, design, and operational information in the one or more stages in the lifecycle of the project; and
an estimation module configured to estimate in-source and outsourced projects based on size of the project and productivity, effort, and schedule involved in the lifecycle of the project.

5. The framework as claimed in claim 1, wherein the support module comprises:
a vision module configured to provide and integrate organization vision in to the one or more stages in the lifecycle of the project;
a knowledge management module configured to define procedures for managing knowledge obtained during the one or more stages in the lifecycle of the project;
a resource management module configured to select optimal resources required for the execution of the project and also to track the resource usage in one or more stages in the life cycle of the project;
global delivery model to ensure the distribution of application and project lifecycle activities and resources, while ensuring their integration;
a stake holder management module configured to identify and manage interests of one or more stake holders in the organization; and
a vendor management module configured to manage vendor engagements.

6. The framework as claimed in claim 1 provides multiple levels of project management certifications to address the competency needs as per various roles requirement in an organization.

7. A method of implementing project management certifications comprising acts of:
identifying competencies and issues involved in one or more stages in a life cycle of a project;
configuring project management certifications based on the competencies and the issues and mapping the project management certifications as per various roles requirement in an organization;
measuring the effectiveness of the project management certifications;
refining the project management certifications as per change in the competencies and the issues in one or more stages in the life cycle of the project; and
finalizing the project management certifications.
